(19) United States
(12) Patent Application Publication
(10) Pub. No.: US 2002/0174300 A1
(43) Pub. Date: Nov. 21, 2002

(54) Data processor and data processing method

(75) Inventors: Atsushi Kotani, Osaka (JP); Yoshiteru Mino, Osaka (JP); Tetsuji Kishi, Osaka (JP)

Correspondence Address: Kenneth L. Cage, Esquire, McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/150,920

(22) Filed: May 21, 2002

(30) Foreign Application Priority Data
May 21, 2001 (JP) 2001-150388

(51) Int. Cl. G06F 12/00

(52) U.S. Cl. 711/123; 711/125

(57) ABSTRACT

In a data processor for processing instruction data composed of an advanced instruction part and a part of data to be operated, efficiency of cache memory control is attained. A predecoder predecodes the advanced instruction part of instruction data before the instruction data is processed. A cache memory controller loads instruction codes required for processing into an instruction cache memory from an instruction code memory based on the predecoding results.

### BACKGROUND OF THE INVENTION

The present invention relates to a technology of control of an instruction cache memory of a data processor for processing instruction data composed of an advanced instruction part and a part of data to be operated.

FIG. 13 is a block diagram of a conventional data processor. The conventional data processor of FIG. 13 includes: a processor 51 for executing both actual processing including operations and control of the processing; an instruction cache memory 52 for the processor 51; a main instruction memory 53 for storing all instructions; a cache memory controller 54 for controlling caching of instruction codes into the instruction cache memory 52; and a main memory 55.

In conventional data processors such as that shown in FIG. 13, control of write, replacement and the like for a cache memory used as an instruction memory is executed in the following manner. The number of ways of the cache memory itself is optimized, and appropriate address mapping is performed with a compiler. And, by referring to an address of an instruction currently executed or fetched, instructions at addresses subsequent to the current address are preread.

When the data processor is a drawing processor where instruction data to be processed is drawing data composed of a part of an advanced instruction such as line drawing and rectangle drawing and a part of data to be operated representing coordinate values for drawing, the following problem arises.

A normal drawing processor executes preprocessing for drawing such as tilt operation and coordinate transformation, by decoding the advanced instruction part of drawing data. The processing to be executed however differs depending on the type of the advanced instruction such as line drawing and character presentation. Moreover, even when the advanced instruction is the same, the processing differs depending on various drawing modes, such as whether or not coordinate transformation is included, whether a solid line or a broken line, and whether or not there is filling-in of a rectangle.

Therefore, since instruction codes to be loaded into the instruction cache memory differ depending on the advanced instruction part of drawing data, optimum control of the cache memory is not attained only with the simple control involving prereading of addresses.

### SUMMARY OF THE INVENTION

An object of the present invention is providing a data processor and a data processing method for processing instruction data composed of an advanced instruction part and a part of data to be operated, in which efficient write and replacement is possible for an instruction cache memory.

To state more specifically, according to the present invention, optimum write and replacement for an instruction cache memory is attained by predecoding an advanced instruction part of instruction data and controlling the instruction cache memory based on the predecoding results.

The data processor of the present invention is a data processor for processing instruction data including an advanced instruction part and a part of data to be operated in one word, including: an instruction data storage section for storing instruction data to be processed; a processing section for receiving instruction data transferred from the instruction data storage section and executing processing according to the instruction data; an instruction code storage section for storing instruction codes used for processing by the processing section; an instruction cache memory for storing an instruction code, the instruction cache memory being accessible by the processing section; a predecoder for predecoding the advanced instruction part of instruction data related to given processing before the processing section executes the given processing; and a cache memory controller for loading an instruction code required for processing by the processing section into the instruction cache memory from the instruction code storage section based on the results of the predecoding by the predecoder.

According to the invention described above, the predecoder predecodes the advanced instruction part of instruction data before the instruction data is processed. Based on the predecoding results, the cache memory controller loads an instruction code required for the processing into the instruction cache memory. By this loading, the hit rate of the instruction cache memory improves, and thus more appropriate control of the instruction cache memory is possible.

Preferably, the instruction data storage section and the instruction code storage section are placed in a single common memory. With this configuration, since a common memory can be used for both instruction data and instruction codes, the number of components can be reduced.

Preferably, the predecoder is placed between the instruction data storage section and the processing section, and predecodes the advanced instruction part of instruction data when the instruction data is being transferred from the instruction data storage section to the processing section.

With the above configuration, since the advanced instruction part of instruction data is predecoded when the instruction data is being transferred from the instruction data storage section to the processing section, the instruction cache memory can be controlled while prediction is being made for instruction data before being processed. Thus, time loss can be reduced.

Preferably, the data processor of the invention described above further includes an external interface for receiving instruction data and an instruction code supplied from outside, wherein the predecoder is placed in the external interface, and predecodes the advanced instruction part of instruction data supplied from outside when the instruction data is being transferred to the instruction data storage section, and the predecoder blocks an instruction code other than the instruction code required for processing related to the supplied instruction data from being transferred to the instruction code storage section, based on the predecoding results.

With the above configuration, the advanced instruction part of instruction data is predecoded when the instruction data supplied from outside is being transferred to the instruction data storage section. In addition, based on the predecoding results, an instruction code other than the instruction code required for processing related to the supplied instruction data is blocked from being transferred to the instruction code storage section. Thus, the capacity of the instruction code storage section can be reduced.

Preferably, the processing section generates processing-completion information for instruction data of which processing has been completed, the information representing an instruction code required for the processing, and the processing section sends the processing-completion information to the cache memory controller. With this configuration, since processing-completion information generated for instruction data of which processing has been completed is sent to the cache memory controller, the instruction cache memory can be immediately updated upon completion of the processing of the instruction data.

Alternatively, the data processor of the present invention is a data processor for processing instruction data including an advanced instruction part and a part of data to be operated in one word, including: a processing section for executing processing according to instruction data received; and an instruction cache memory for storing an instruction code, the instruction cache memory being accessible by the processing section, wherein the advanced instruction part of the instruction data related to given processing is predecoded before the processing section executes the given processing, and based on the predecoding results, an instruction code required for processing by the processing section is loaded into the instruction cache memory.

According to the invention described above, the predecoder predecodes the advanced instruction part of instruction data before the instruction data is processed. Based on the predecoding results, an instruction code required for the processing is loaded into the instruction cache memory. By this loading, the hit rate of the instruction cache memory improves, and thus more appropriate control of the instruction cache memory is possible.

According to another aspect of the invention, a data processing method is provided. The method is for processing instruction data including an advanced instruction part and a part of data to be operated in one word with a data processor having an instruction cache memory, and includes the steps of: (1) predecoding the advanced instruction part of given instruction data before the given instruction data is processed; and (2) loading an instruction code required for processing of the instruction data into the instruction cache memory based on the results of the predecoding in step (1).

According to the invention described above, the advanced instruction part of instruction data is predecoded before the instruction data is processed. Based on the predecoding results, an instruction code required for the processing is loaded into the instruction cache memory. By this loading, the hit rate of the instruction cache memory improves, and thus more appropriate control of the instruction cache memory is possible.

### BRIEF DESCRIPTION OF THE DRAWINGS

FIG. 1 is a block diagram of a drawing processor of Embodiment 1 of the present invention.

FIGS. 2A and 2B show examples of drawing data.

FIG. 3 is a flowchart of processing executed by the drawing processor of FIG. 1.

FIG. 4 is a block diagram of a drawing processor of Embodiment 2 of the present invention.

FIGS. 5A and 5B show examples of data stored in an instruction cache table.

FIG. 6 is a flowchart of processing executed by the drawing processor of FIG. 4.

FIG. 7 is a timing chart conceptually showing the operation of the drawing processor of FIG. 4.

FIG. 8 is a block diagram of a drawing processor of Embodiment 3 of the present invention.

FIG. 9 is a flowchart of processing executed by the drawing processor of FIG. 8.

FIG. 10 is a block diagram of a drawing processor of Embodiment 4 of the present invention.

FIG. 11 is a flowchart of updating of an instruction cache table.

FIG. 12 is a flowchart of processing executed by the drawing processor of FIG. 10.

FIG. 13 is a block diagram of a conventional data processor.

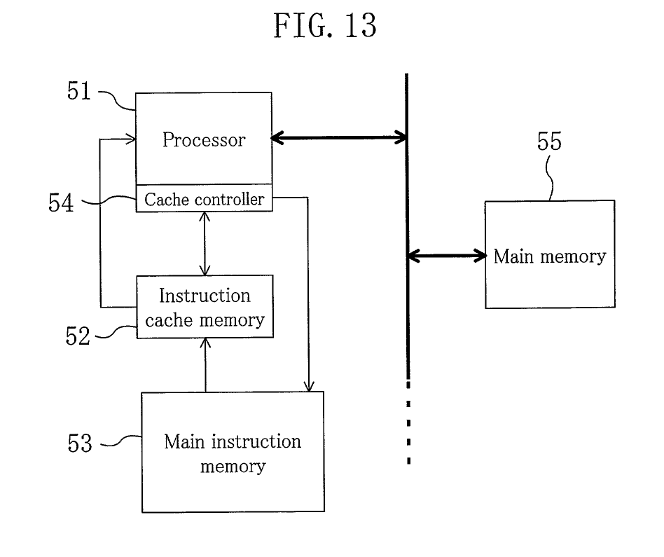

### DESCRIPTION OF THE PREFERRED EMBODIMENTS

Hereinafter, preferred embodiments of the present invention will be described with reference to the accompanying drawings. Note that although a drawing processor for processing drawing data for graphics is exemplified in the following description, the present invention is also applicable to other data processors for processing instruction data of which each word includes both an advanced instruction part and a part of data to be operated.

Embodiment 1

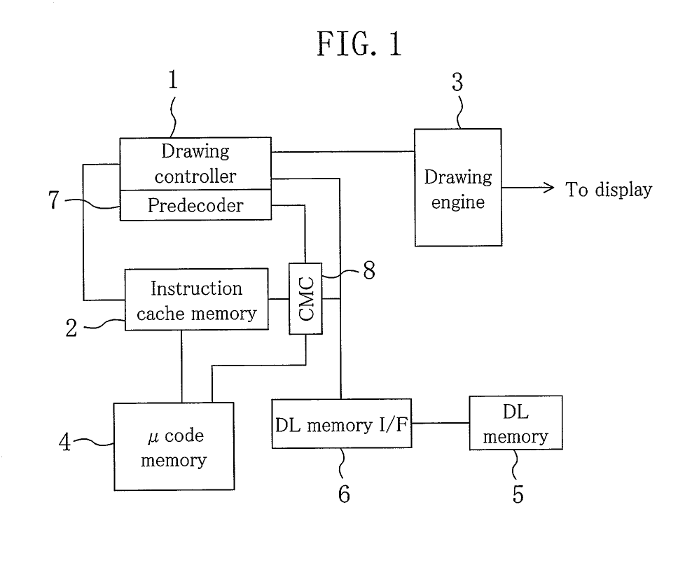

FIG. 1 is a block diagram of a drawing processor as the data processor of Embodiment 1 of the present invention. The drawing processor of FIG. 1 includes: a drawing controller 1 for executing overall control of the drawing processor; an instruction cache memory 2 as an instruction memory to which the drawing controller 1 directly accesses; a drawing engine 3 for executing actual drawing; a microcode memory 4 as an instruction code storage section for storing instruction codes used for drawing; a DL memory 5 as an instruction data storage section for storing drawing data (DL) to be processed for drawing; a DL memory interface (I/F) 6 used for exchange of drawing data between the drawing controller 1 and the DL memory 5; a predecoder 7 for predecoding drawing data sent to the drawing controller 1 from the DL memory 5 before start of processing of the drawing data by the drawing controller 1; and a cache memory controller (CMC) 8. The cache memory controller 8, which receives the predecoding results from the predecoder 7, loads instruction codes required for processing by the drawing controller 1 into the instruction cache memory 2 from the microcode memory 4, and controls replacement and the like of instruction codes as required. The drawing controller 1 and the drawing engine 3 constitute the processing section.

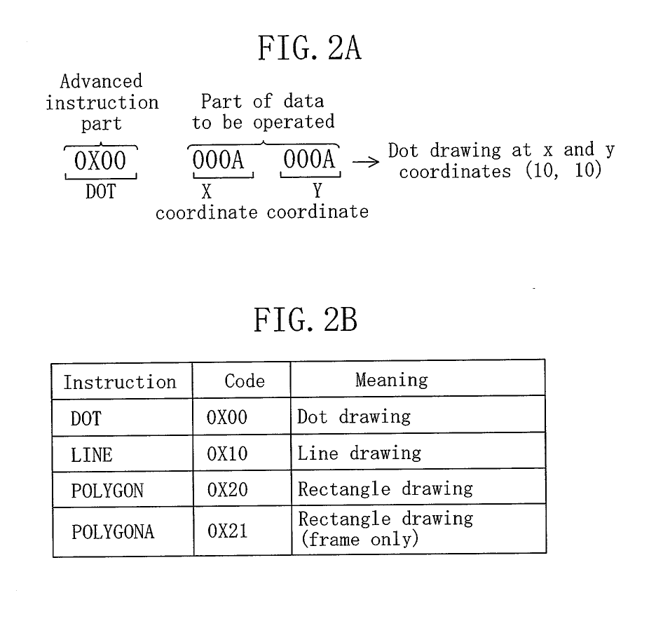

FIG. 2A shows an example of drawing data, representing “dot drawing at x and y coordinates (10, 10)”. The initial 16-bit command DOT corresponds to the advanced instruction part, and the subsequent 32-bit part representing the coordinate values corresponds to the part of data to be operated. FIG. 2B shows other examples of the advanced instruction part. Note that the number of bits of the part of data to be operated varies with the type of processing of drawing data, the number of coordinate values and the like.

The predecoder 7 predecodes the advanced instruction part of drawing data as that shown in FIGS. 2A and 2B, and determines what type of drawing is to be executed with the drawing data (for example, “drawing of a line having 5 vertexes with coordinate transformation” and “drawing of a rectangle represented by relative coordinates from a reference point with filling-in”). The cache memory controller 8 receives information on the type of drawing data to be processed from the predecoder 7 and controls the instruction cache memory 2.

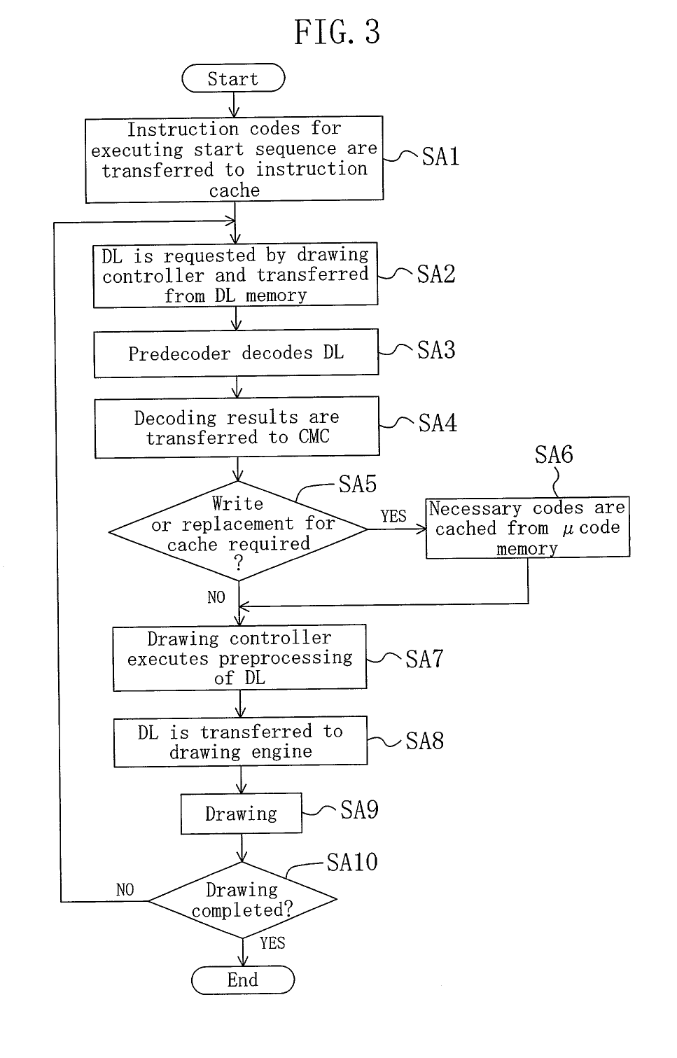

FIG. 3 is a flowchart of processing executed by the drawing processor of FIG. 1. Referring to FIG. 3, the operation of the drawing processor of FIG. 1 will be described.

In step SA1, upon activation of the drawing processor, the cache memory controller 8 loads instruction codes, required for the drawing controller 1 to execute an initial sequence of the drawing processor, into the instruction cache memory 2 from the microcode memory 4 in response to a start signal.

In step SA2, the drawing controller 1 executes instruction codes and retrieves required drawing data from the DL memory 5. In step SA3, the predecoder 7 predecodes the advanced instruction part of the drawing data retrieved in step SA2 to specify the type. In step SA4, the predecoder 7 transfers the results of the predecoding in step SA3 to the cache memory controller 8.

In step SA5, the cache memory controller 8 examines whether or not instruction codes required for processing of the retrieved drawing data exist in the instruction cache memory 2, that is, whether or not a cache hit occurs. If no hit occurs and it is determined that replacement or write of the instruction codes is necessary (YES in step SA5), the instruction codes required are written in the instruction cache memory 2 from the microcode memory 4 in step SA6. The process then proceeds to step SA7. If a cache hit occurs (NO in step SA5), the process directly proceeds to step SA7.

In step SA7, the drawing controller 1 executes preprocessing for the drawing data in accordance with the instruction codes in the instruction cache memory 2. In step SA8, the drawing data preprocessed in step SA7 is transferred to the drawing engine 3. In step SA9, the drawing engine 3 executes drawing with the transferred drawing data. In step SA10, if the drawing controller 1 determines that all the drawing work has been completed (YES), the process is terminated. If not (NO), the process returns to step SA2 to continue the drawing work.

As described above, in this embodiment, drawing data in a special form is predecoded before execution of drawing, and the predecoding results are used for control of write and replacement of instruction codes in the instruction cache memory. Thus, more reliable cache management is attained for the instruction cache memory.

Embodiment 2

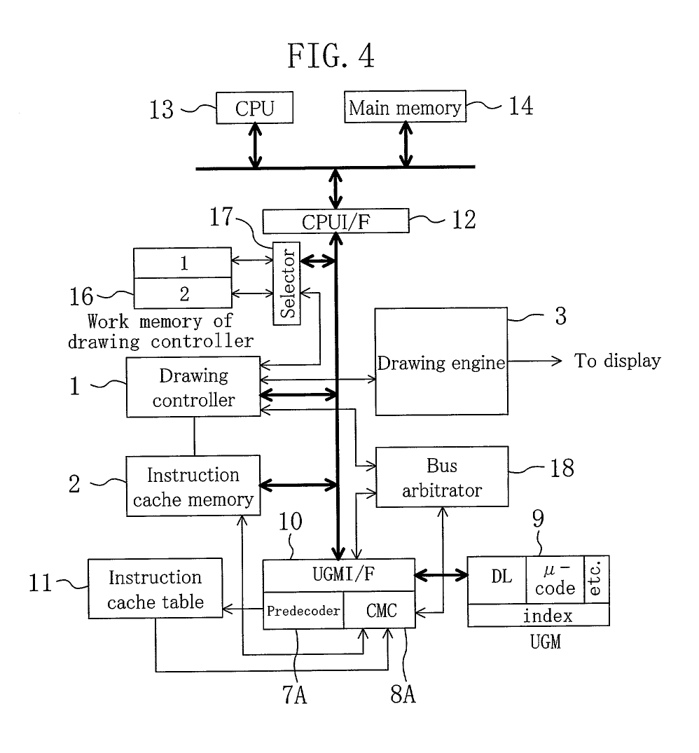

FIG. 4 is a block diagram of a drawing processor of Embodiment 2 of the present invention. In FIG. 4, the same components as those in FIG. 1 are denoted by the same reference numerals, and the description thereof is omitted here.

Features of the drawing processor of FIG. 4 are as follows. A common memory (UGM) 9 is provided for storing both instruction codes and drawing data. In other words, the instruction data storage section and the instruction code storage section are placed in the single common memory 9. With this unification of the memory for instruction codes and the memory for drawing data, the number of components can be reduced.

A common memory interface (UGM I/F) 10 is provided for exchange of drawing data between the common memory 9 and the drawing controller 1. A predecoder 7A and a cache memory controller (CMC) 8A are placed in the common memory interface 10. In addition, an instruction cache table 11 is provided for storing predecoding results from the predecoder 7A.

The predecoder 7A predecodes the advanced instruction part of drawing data transferred from the common memory 9 to the drawing controller 1. The instruction cache table 11 stores a map of addresses of instruction codes in the common memory 9, in addition to the predecoding results from the predecoder 7A. The cache memory controller 8A loads instruction codes required for processing by the drawing controller 1 into the instruction cache memory 2 from the common memory 9 by referring to the instruction cache table 11, and controls replacement and the like of instruction codes as required.

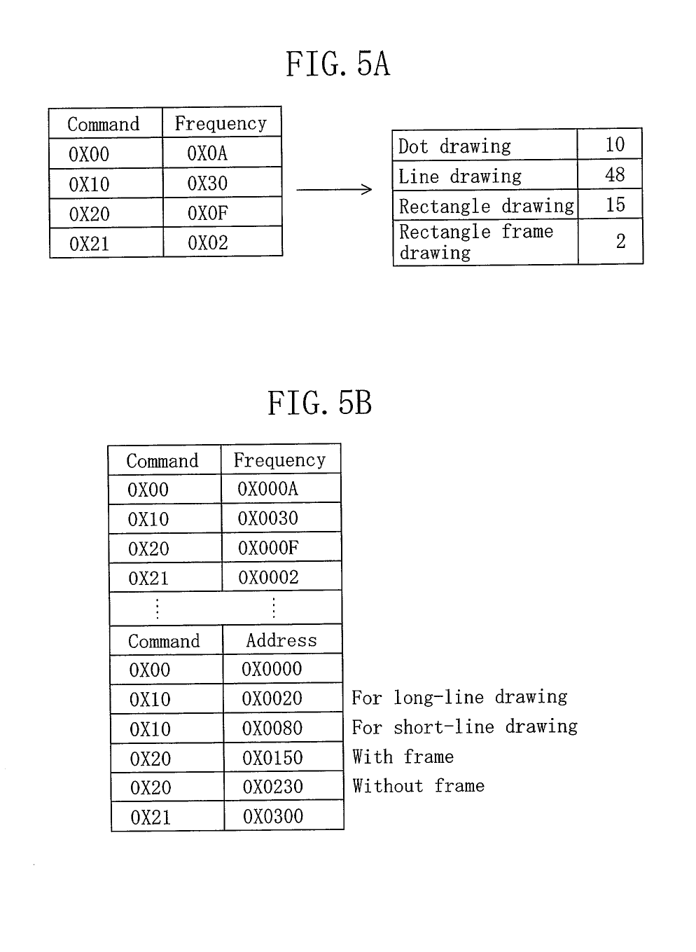

FIGS. 5A and 5B show examples of data stored in the instruction cache table 11. While FIG. 5A shows storage of only commands each corresponding to the advanced instruction part of data, FIG. 5B additionally implements address correspondence with the common memory 9. In the example of FIG. 5A, the number of times each command occurs in drawing data is shown as the frequency for the respective commands such as dot drawing and line drawing. In the example of FIG. 5B, the address in the common memory 9 at which each command is stored is shown, in addition to the frequency.

The drawing processor of FIG. 4 further includes: a work memory 16 for holding drawing data transferred to the drawing controller 1 via the common memory interface 10 and also serving as a storage of results of calculation by the drawing controller 1 and the like; a selector 17 for switching the access region of the work memory 16; and a bus arbitrator 18 for arbitrating access to local buses inside the drawing processor. The drawing controller 1, the drawing engine 3, the work memory 16 and the selector 17 constitute the processing section.

A CPU 13, which is a master of the drawing processor of this embodiment, supplies drawing data stored in a main memory 14 to the drawing processor. The drawing processor includes a CPU interface (CPU I/F) 12 as an external interface for access to the CPU 13 to receive drawing instructions from the CPU 13.

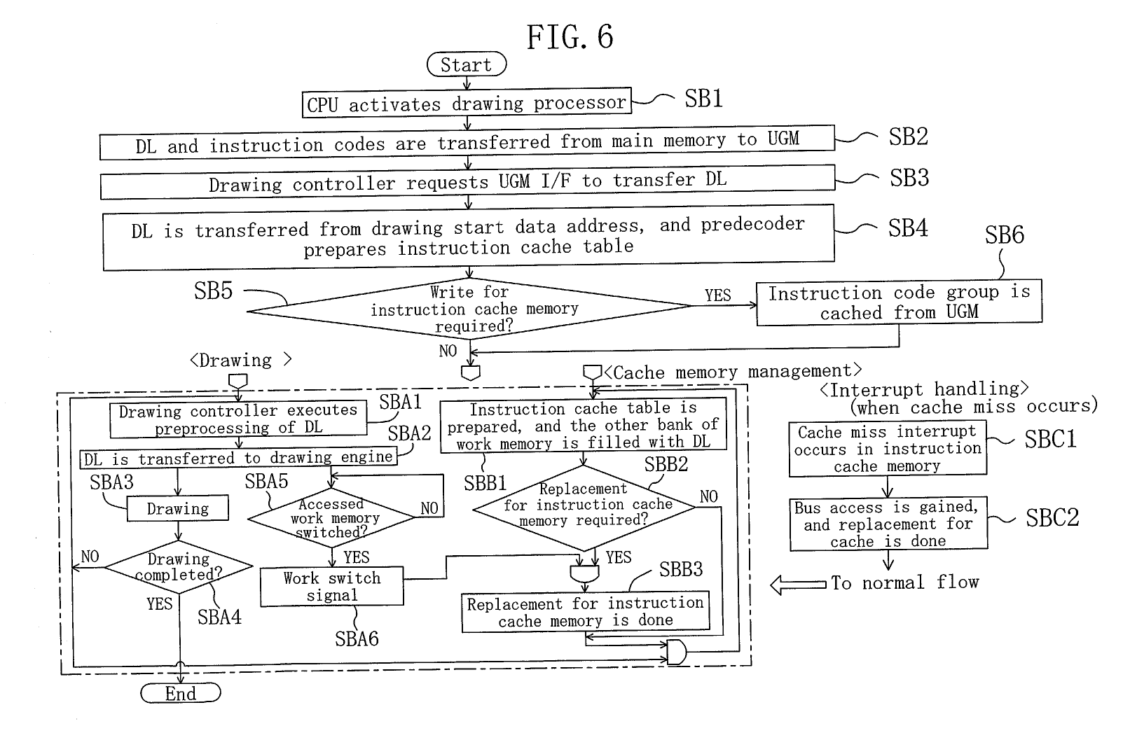

FIG. 6 is a flowchart of the processing executed by the drawing processor of FIG. 4. Referring to FIG. 6, the operation of the drawing processor of FIG. 4 will be described.

In step SB1, the CPU 13 activates the drawing processor of this embodiment. In step SB2, the CPU 13 transfers drawing data and an instruction code group from the main memory 14 to the common memory 9. In step SB3, upon completion of the transfer, the drawing controller 1 requests the common memory interface 10 to fill bank 1 of the work memory 16 with drawing data in a range designated by the CPU 13.

In step SB4, the common memory interface 10 starts transfer of the drawing data from a drawing start data address. During the passing of the drawing data through the common memory interface 10, the predecoder 7A predecodes the advanced instruction part of the drawing data, and from the results of the predecoding, prepares a table showing information on the type of the advanced instruction in the instruction cache table 11, in addition to an address map of instruction codes in the common memory 9.

In step SB5, the cache memory controller 8A examines whether or not write is necessary for an instruction code group currently under entry in the instruction cache memory 2, based on the table prepared in step SB4. If it is determined necessary (YES in step SB5), the cache memory controller 8A requests the bus arbitrator 18 to permit bus access. Once the cache memory controller 8A gains bus access, it transfers a required instruction code group from the common memory 9 to the instruction cache memory 2 in step SB6.

In the subsequent process steps, a series of steps SBAn indicate a flow of drawing processing, a series of steps SBBn indicate a flow of management of the cache memory, and a series of steps SBCn indicate a flow of interrupt handling, that is, processing executed when a cache miss occurs in the access to the cache memory.

In the drawing processing, in step SBA1, the drawing controller 1 decodes drawing data and performs preprocessing before actual drawing, such as tilt operation, clipping and coordinate transformation. In step SBA2, the preprocessed drawing data is transferred from the drawing controller 1 to the drawing engine 3. In step SBA3, the drawing engine 3 executes drawing with the transferred drawing data. In step SBA4, the drawing controller 1 examines whether or not the drawing requested to execute by the CPU 13 has been completed. If completed (YES), the drawing controller 1 is put in a standby state until it is activated again by the CPU 13. If not completed (NO), the process returns to step SBA1 to continue the processing.

During the transfer of the drawing data (step SBA2), it is examined whether or not switch of the bank of the work memory 16 to which the drawing controller 1 accesses occurs in step SBA5. If switch of the bank occurs (YES), a switch signal is sent to the selector 17 and the cache memory controller 8A in step SBA6, to start switch of the connection of the work memory 16, filling with drawing data, monitoring of the instruction cache memory 2, and the like.

The cache memory management is executed in the initial sequence, starting earlier than step SBA1, and after that, executed every time the bank of the work memory 16 is switched. In step SBB1, the predecoder 7A predecodes the advanced instruction part of drawing data, and prepares a table showing information on the type of the advanced instruction in the instruction cache table 11 as in step SB4. When the drawing controller 1 is under access to one of the banks of the work memory 16, the other bank is filled with drawing data of which transfer has been requested by the drawing controller 1. During the filling, the predecoder 7A prepares a table related to the drawing data being transferred to the other bank.

In step SBB2, the cache memory controller 8A determines whether or not replacement is necessary for instruction codes currently under entry in the instruction cache memory 2 by referring to the instruction cache table 11 prepared in step SBB1, so as to be ready for coming processing by the drawing controller 1 for the bank currently being filled with drawing data. If it is determined that replacement is necessary (YES in step SBB2), the cache memory controller 8A writes the instruction codes required in the instruction cache memory 2 from the common memory 9 once the bank switch signal of the work memory 16 is output (step SBA6), in step SBB3.

The above series of processing is repeated until termination of the drawing is determined in step SBA4.

The interrupt handling executed when a cache miss occurs is as follows. When the drawing controller 1 executing the processing in step SBA1 determines that instruction codes required are not available in the instruction cache memory 2 (when a cache miss occurs), a cache miss interrupt occurs in step SBC1. In step SBC2, the cache memory controller 8A forcefully gains bus access from the bus arbitrator 18 and immediately writes the required instruction codes in the instruction cache memory 2. Thereafter, the processing halted due to the interrupt is resumed.

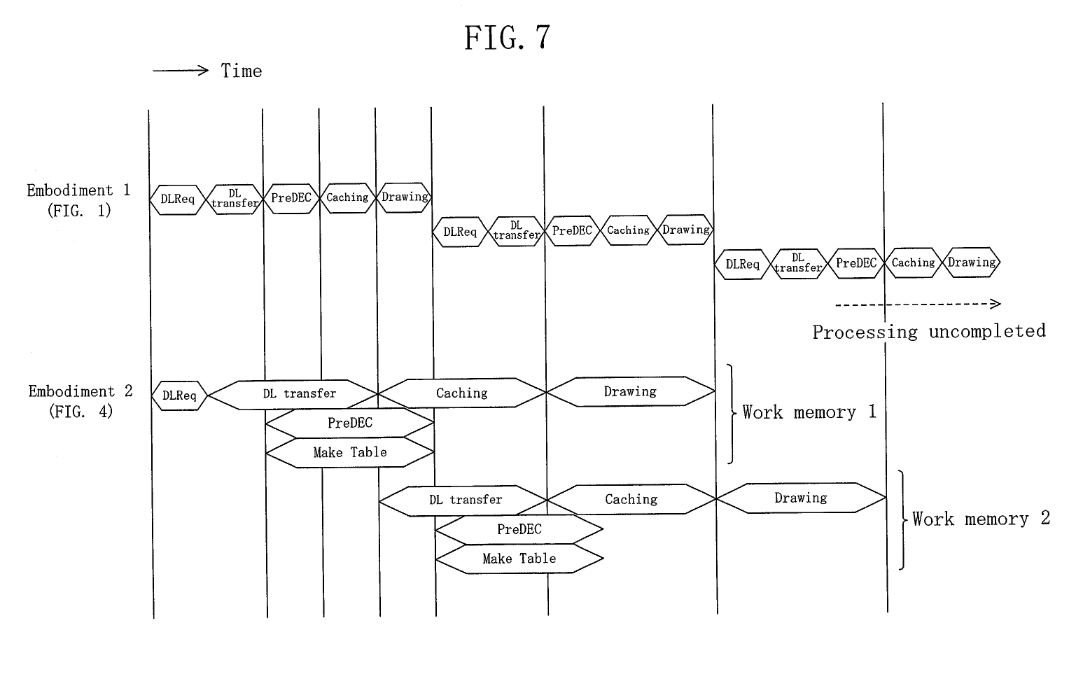

FIG. 7 is a timing chart conceptually showing the operation of the drawing processor of this embodiment. In FIG. 7, the operation of the drawing processor of Embodiment 1 is also shown for comparison. In FIG. 7, it is assumed that the drawing processor of FIG. 4 includes an exclusive memory, not the local memory, as the instruction memory connected to the instruction cache memory, as in the drawing processor of FIG. 1 to match the conditions with those in Embodiment 1.

As is found from FIG. 7, in Embodiment 1, the entire processing from the transfer of drawing data through the drawing is executed in series. In this embodiment, however, the transfer of drawing data and the predecoding can be executed in parallel because the predecoder 7A is placed in the common memory interface 10. In addition, the drawing can be executed in parallel with the transfer of drawing data and the cache control because the work memory 16 is composed of two banks. That is, in this embodiment, the processing speed is improved over that in Embodiment 1.

In this embodiment, the predecoder 7A is placed in the common memory interface 10. However, the position of predecoder 7A is not limited to this, but may be anywhere as long as predecoding of the advanced instruction part of drawing data is possible while the drawing data is being transferred to the drawing controller. For example, when the memory for storing drawing data is not a common memory but an exclusive memory, the predecoder may be placed somewhere on the route through which the drawing data is transferred from the memory to the drawing controller.

Embodiment 3

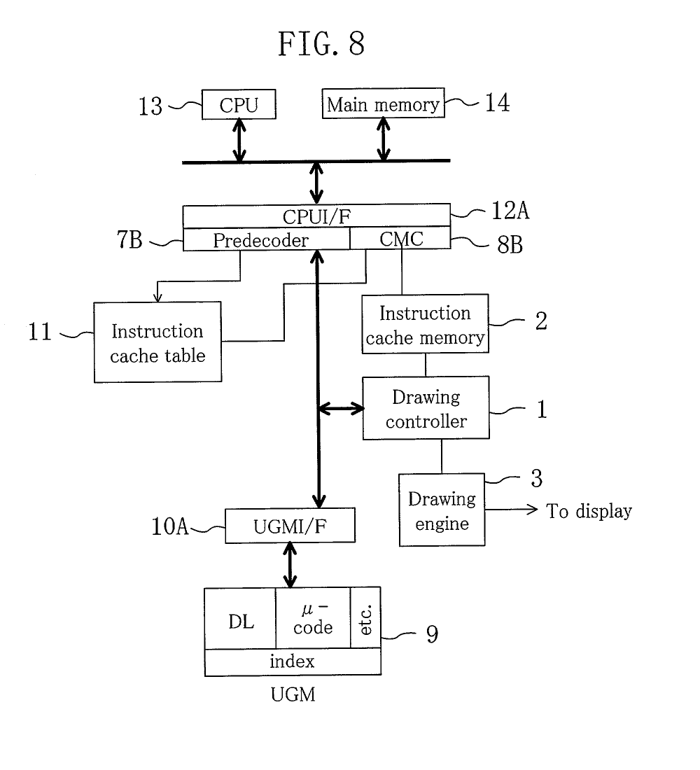

FIG. 8 is a block diagram of a drawing processor of Embodiment 3 of the present invention. In FIG. 8, the same components as those in FIG. 1 or FIG. 4 are denoted by the same reference numerals, and the description thereof is omitted here. In the drawing processor of FIG. 8, a predecoder 7B and a cache memory controller (CMC) 8B are placed, not in the common memory interface 10A, but in a CPU interface 12A as an external interface.

The predecoder 7B predecodes the advanced instruction part of drawing data transferred from the external main memory 14, and prepares an address map for optimum placement of instruction codes sent to the common memory 9 using the predecoding results. The predecoding results and the prepared instruction code address map are stored in the instruction cache table 11. The cache memory controller 8B controls replacement and write of instruction codes in the instruction cache memory 2 by referring to the instruction cache table 11.

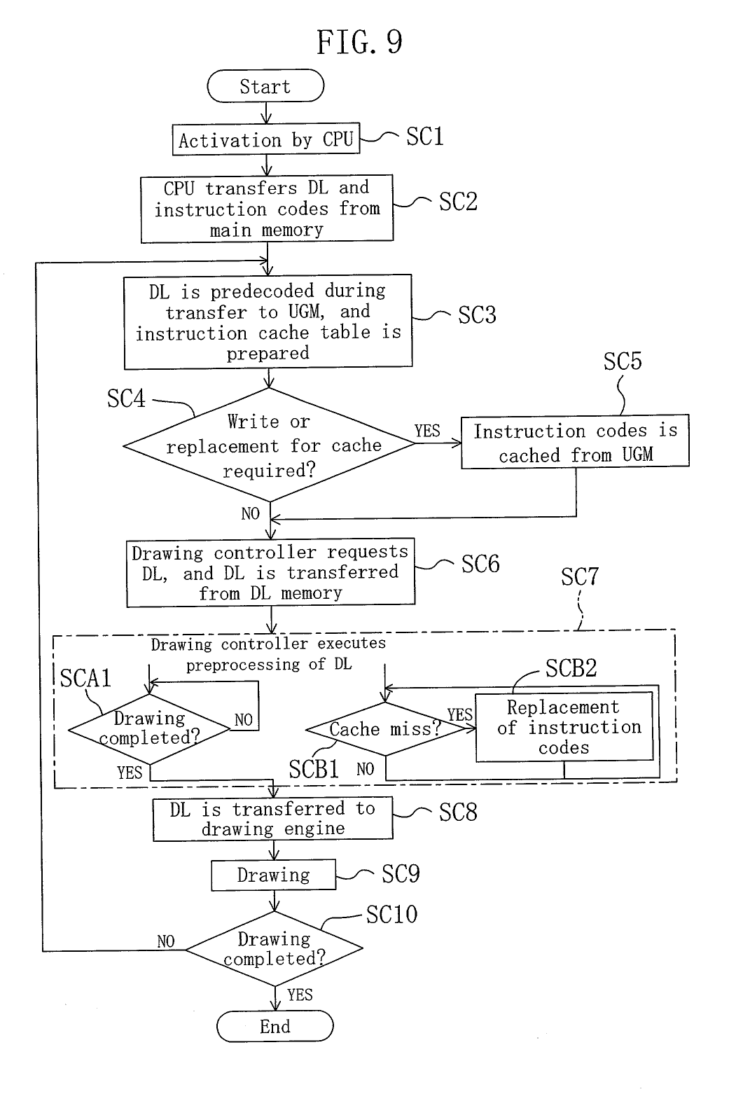

FIG. 9 is a flowchart of processing executed by the drawing processor of FIG. 8. Referring to FIG. 9, the operation of the drawing processor of FIG. 8 will be described.

In step SC1, the CPU 13 activates the drawing processor of this embodiment, or to be strict, activates the drawing controller 1. In step SC2, the CPU 13 transfers drawing data and relevant instruction codes from the main memory 14 to the common memory 9.

In step SC3, during the transfer of the drawing data, the predecoder 7B predecodes the advanced instruction part of the drawing data and stores the results in the instruction cache table 11.

Only instruction codes required for the transferred drawing data are transferred to the common memory 9 by referring to the predecoding results stored in the instruction cache table 11. At the same time, instruction codes in the common memory 9 are mapped optimally in accordance with the drawing data address map stored in the instruction cache table 11, for improvement of the hit rate. The “optimum” mapping as used herein refers to not only attaining optimum mapping of the index of the common memory 9 in consideration of the number of ways of the instruction cache memory 2, but also enabling a group of relevant instruction codes related to each advanced instruction part to be written at continuous addresses in the instruction cache memory 2. The address map of instruction codes in the common memory 9 is also stored in the instruction cache table 11 additionally.

In step SC4, the cache memory controller 8B determines whether or not replacement or write is necessary for the instruction code group currently under entry in the instruction cache memory 2. If it is determined necessary (YES), required instruction codes are loaded into the instruction cache memory 2 from the common memory 9 in step SC5, and the process proceeds to step SC6. If it is determined unnecessary (NO), the process directly proceeds to step SC6. In step SC6, the drawing controller 1 requests transfer of drawing data. In response to this request, the common memory interface 10A transfers the drawing data.

Processing in step SC7 is divided into two: drawing processing and cache memory management. In the drawing processing, in step SCA1, it is examined whether or not the drawing controller 1 has completed the processing for the drawing data to be processed. Simultaneously with this step, the following cache memory management is executed. In step SCB1, the drawing controller 1 monitors whether or not a cache miss of instruction codes occurs. If a miss occurs (YES), replacement of instruction codes is made for the instruction cache memory 2 in step SCB2.

When the drawing controller 1 has completed the processing for given drawing data (YES in step SCA1), the drawing controller 1 transfers the drawing data to the drawing engine 3 in step SC8. In step SC9, the drawing engine 3 executes drawing with the transferred drawing data. In step SC10, whether or not the drawing controller 1 has completed all the drawing processing is determined. If completed, the operation of the drawing processor is terminated. If not, the process returns to step SC3, to continue the drawing processing repeatedly.

Thus, in this embodiment, the CPU interface 12A is provided with the predecoder 7B for predecoding drawing data when it is being sent from the CPU 13 as the master of the drawing processor of this embodiment. Based on the predecoding results, only instruction codes required for processing related to the drawing data is transferred to the common memory 9 while the other instruction codes are blocked from being transferred to the common memory 9. With this configuration, it is possible to reduce the area of the instruction code storage region in the common memory 9.

In addition, since the address mapping for the common memory 9 is made to optimize the management of the instruction cache memory 2, the hit rate can further be improved. In other words, appropriate management of the instruction cache memory 2 is attained for the drawing of one macro-unit of drawing data transferred from the CPU 13 to the drawing processor.

In this embodiment, the instruction data storage section and the instruction code storage section are placed in the single common memory 9. Alternatively, they may be placed separately.

Embodiment 4

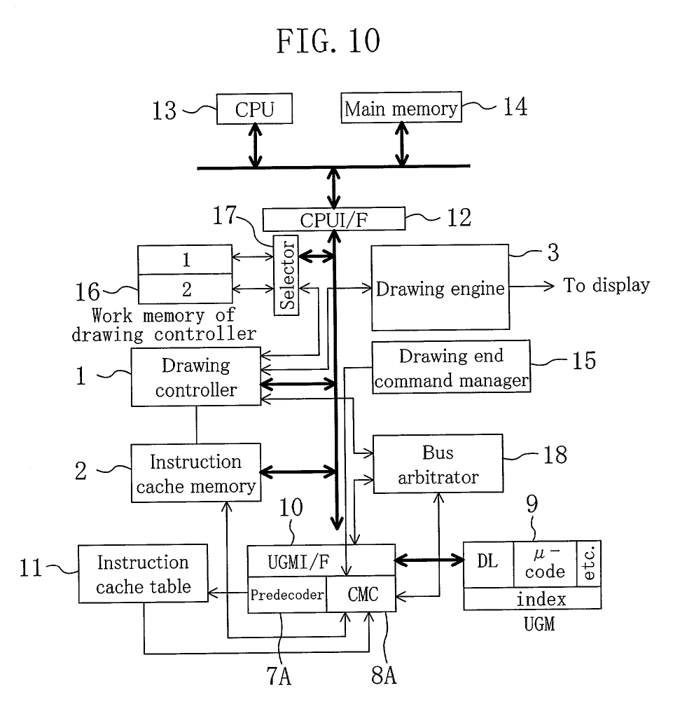

FIG. 10 is a block diagram of a drawing processor of Embodiment 4 of the present invention. In FIG. 10, the same components as those in FIG. 4 are denoted by the same reference numerals, and the description thereof is omitted here. The drawing processor of FIG. 10 is different from the drawing processor of FIG. 4 in that a drawing end command manager 15 is additionally provided. The drawing controller 1, the drawing engine 3, the work memory 16, the selector 17 and the drawing end command manager 15 constitute the processing section.

The drawing end command manager 15 decodes drawing data transferred from the drawing controller 1 to the drawing engine 3, and based on the decoding results, requests the cache memory controller 8A to update the instruction cache table 11. To state more specifically, when processing is completed for given drawing data, the drawing end command manager 15 generates processing-completion information representing instruction codes used for the processing of the drawing data, and sends the information to the cache memory controller 8A. From the received processing-completion information, the cache memory controller 8A knows which instruction codes are no more necessary, and thus can execute replacement of the instruction codes in the instruction cache memory 2 at an appropriate time.

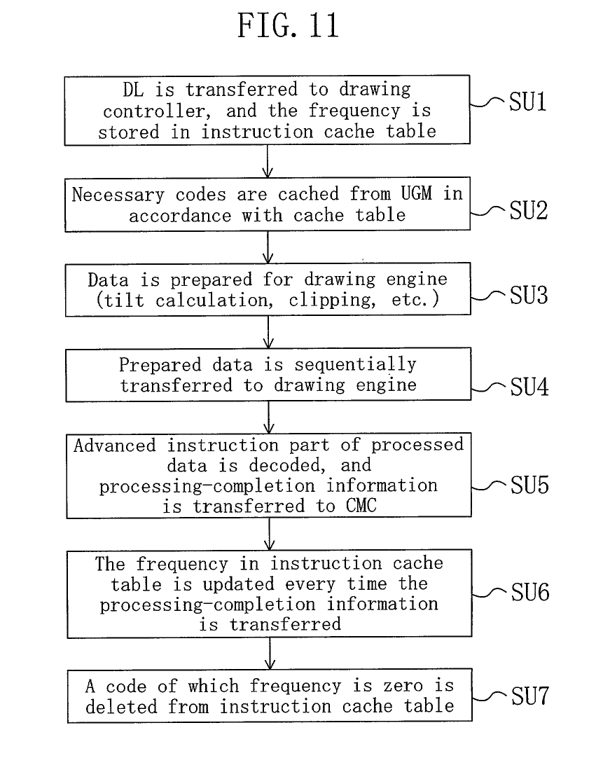

FIG. 11 is a flowchart of updating of the instruction cache table executed by the drawing processor of FIG. 10.

In step SU1, the common memory interface 10 transfers drawing data to the drawing controller 1. At the same time, the predecoder 7A predecodes the drawing data and stores the frequency of each type of command in the drawing data in the instruction cache table 11. In step SU2, the cache memory controller 8A writes required instruction codes in the instruction cache memory 2 from the common memory 9.

In step SU3, the drawing controller 1 performs preprocessing such as tilt calculation, clipping and the like to prepare for transfer to the drawing engine 3. In step SU4, the prepared drawing data is sequentially transferred to the drawing engine 3. In step SU5, the drawing end command manager 15 decodes the advanced instruction part of the drawing data of which processing has been completed, generates processing-completion information representing instruction codes required for the processing, and sends the information to the cache memory controller 8A.

In step SU6, upon receipt of the processing-completion information from the drawing end command manager 15, the cache memory controller 8A updates the frequency of each command in the instruction cache table 11. Also, when the cache memory controller 8A finds an instruction code of which the frequency is zero, it deletes this instruction code from the entry in the instruction cache memory 2.

That is, while the drawing controller 1 sequentially executes data processing for drawing data in the work memory 16, instruction codes required only for the already-transferred drawing data can be deleted from the instruction cache memory 2. In view of this, in this embodiment, the instruction cache table 11 is updated at the time when the drawing data has been transferred to the drawing engine 3. In this way, advance replacement of instruction codes in the instruction cache memory 2 is possible before completion of the processing for the accessed bank of the work memory 16.

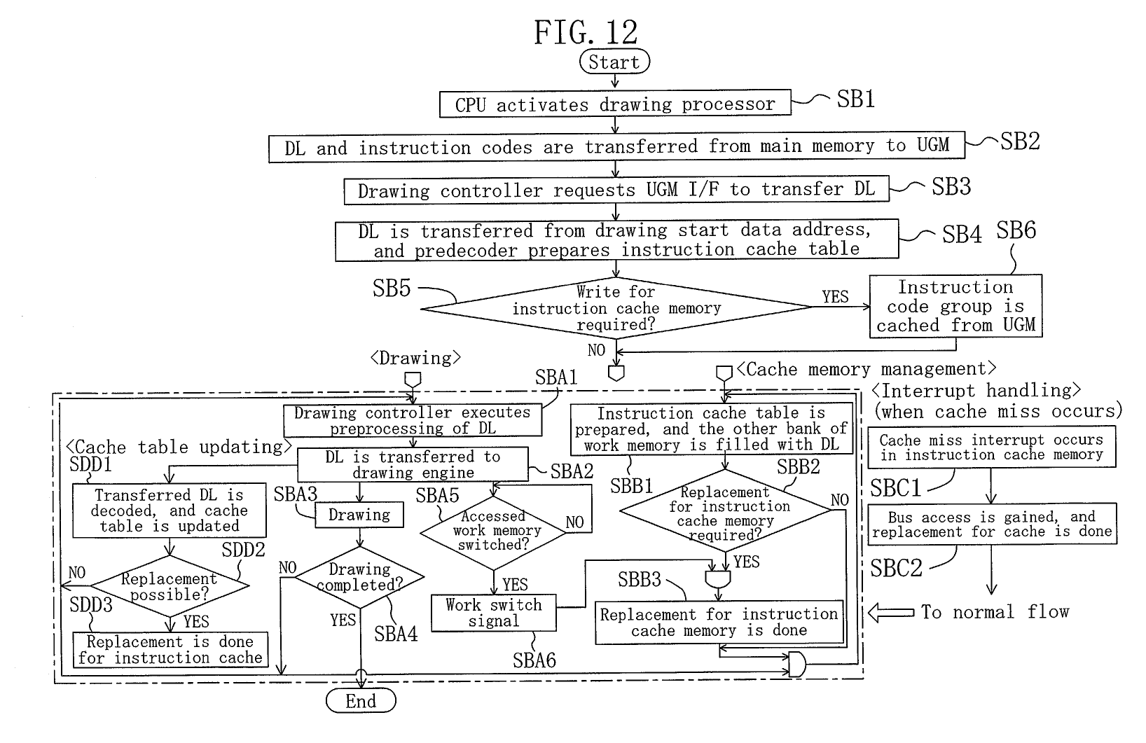

FIG. 12 is a flowchart of the processing executed by the drawing processor of this embodiment. The flow of processing in FIG. 12 is the same as that in FIG. 6, except that steps SDD1 to SDD3 for updating the instruction cache table are added to the steps in FIG. 6. Therefore, the same steps as those in FIG. 6 are denoted by the same reference codes, and the description thereof is omitted here.

In step SDD1, the advanced instruction part of the drawing data transferred to the drawing engine 3 in step SBA2 is decoded, to examine the drawing data of which processing by the drawing controller 1 has been completed, and based on the examination results, the instruction cache table 11 is updated. In step SDD2, the cache memory controller 8 examines the updated instruction cache table 11 and determines whether or not replacement is possible. If it is determined possible (YES), the cache memory controller 8A requests the bus arbitrator 18 to permit bus access in step SDD3. Once the cache memory controller 8A gains bus access permission from the bus arbitrator 18, it executes replacement of unnecessary instruction codes in the instruction cache memory 2.

Thus, in this embodiment, the drawing end command manager 15 is provided for managing drawing data of which processing by the drawing controller 1 has been completed. With this management, advance replacement of instruction codes in the instruction cache memory is attained.

In this embodiment, the instruction data storage section and the instruction code storage section are placed in the single common memory. Alternatively, they may be placed separately.

In this embodiment, although the predecoder 7A is placed in the common memory interface 10, it may be placed in another place.

Thus, according to the present invention, the advanced instruction part of instruction data is predecoded before the instruction data is processed. Based on the predecoding results, instruction codes required for the processing are loaded into the instruction cache memory. By this loading, the hit rate of the instruction cache memory is improved, and thus more appropriate control of the instruction cache memory is possible.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A data processor for processing instruction data including an advanced instruction part and a part of data to be operated in one word, the processor comprising:
an instruction data storage section for storing instruction data to be processed;
a processing section for receiving instruction data transferred from the instruction data storage section and executing processing according to the instruction data;
an instruction code storage section for storing instruction codes used for processing by the processing section;
an instruction cache memory for storing an instruction code, the instruction cache memory being accessible by the processing section;
a predecoder for predecoding the advanced instruction part of instruction data related to given processing before the processing section executes the given processing; and
a cache memory controller for loading an instruction code required for processing by the processing section into the instruction cache memory from the instruction code storage section based on the results of the predecoding by the predecoder.

2. The data processor of claim 1, wherein the instruction data storage section and the instruction code storage section are placed in a single common memory.

3. The data processor of claim 1, wherein the predecoder is placed between the instruction data storage section and the processing section, and predecodes the advanced instruction part of instruction data when the instruction data is being transferred from the instruction data storage section to the processing section.

4. The data processor of claim 1, further comprising an external interface for receiving instruction data and instruction codes supplied from outside,
wherein the predecoder is placed in the external interface, and predecodes the advanced instruction part of instruction data supplied from outside when the instruction data is being transferred to the instruction data storage section, and
the predecoder blocks an instruction code other than the instruction code required for processing related to the supplied instruction data from being transferred to the instruction code storage section, based on the predecoding results.

5. The data processor of claim 1, wherein the processing section generates processing-completion information for instruction data of which processing has been completed, the information representing an instruction code required for the processing, and the processing section sends the processing-completion information to the cache memory controller.

6. The data processor of claim 1, wherein the instruction data is drawing data for graphics.

7. A data processor for processing instruction data including an advanced instruction part and a part of data to be operated in one word, the processor comprising:
a processing section for executing processing according to instruction data received; and
an instruction cache memory for storing an instruction code, the instruction cache memory being accessible by the processing section,
wherein the advanced instruction part of the instruction data related to given processing is predecoded before the processing section executes the given processing, and
based on the predecoding results, an instruction code required for processing by the processing section is loaded into the instruction cache memory.

8. A data processing method for processing instruction data including an advanced instruction part and a part of data to be operated in one word with a data processor having an instruction cache memory, the method comprising the steps of:
(1) predecoding the advanced instruction part of given instruction data before the given instruction data is processed; and
(2) loading an instruction code required for processing of the instruction data into the instruction cache memory based on the results of the predecoding in step (1).
